(19) United States
(12) Patent Application Publication
(10) Pub. No.: US 2015/0257599 A1
(43) Pub. Date: Sep. 17, 2015

(54) PET FLAVOR GRINDING APPARATUS AND METHOD

(71) Applicant: FFD Designs (Canada) Inc., Richmond Hill (CA)

(72) Inventors: Cheryl NG, Richmond Hill (CA); Lina FRANCO, St Lazare (CA)

(73) Assignee: FFD Designs (Canada) Inc., Richmond Hill (CA)

(21) Appl. No.: 14/644,299

(22) Filed: Mar. 11, 2015

(30) Foreign Application Priority Data
Mar. 11, 2014 (CA) 2846056

(51) Int. Cl. A47J 42/14; A23K 1/16

(52) U.S. Cl. CPC A47J 42/14; A23K 1/16

(57) ABSTRACT

A pet flavor grinding apparatus, pet flavor tablet and a method for grinding such a tablet are described. In an embodiment, a pet flavor grinding apparatus includes a pet flavor tablet. The pet flavor tablet includes a plurality of ingredients. The apparatus includes a container defining a tablet-storing space therein storing the tablet. The apparatus also includes a grinding mechanism coupled to the container and in communication with the tablet-storing space for receiving the tablet. The grinding mechanism includes two spaced-apart grinding elements. One of the grinding elements is movable relative to the other grinding element for grinding the tablet for discharge on pet food when the tablet is positioned in between the grinding elements.

This application claims priority to Canadian application number 2,846,056 which was filed Mar. 11, 2014, the contents of which are incorporated herein by reference.

### FIELD

The present application relates to pet food flavor enhancers and, more particularly, to an apparatus and method for grinding a multi-ingredient pet flavor tablet for discharge on pet food.

### BACKGROUND

Pet food is food specifically manufactured for consumption by pets. Similar to humans, it is important that pets receive proper nutritional content from their food. Unfortunately, some pets may have poor dietary habits and may refuse to adequately consume pet food that serves their nutritional needs (for example, due to lack of flavor). Pets may have a disposition to eat unhealthy foods, such as food that may be flavorful but low in nutritional content. In such cases, a pet may not be adequately meeting its daily nutritional needs.

As such, there is a need to provide food for pets that provides both nutritional value and flavor so as to be healthy and enjoyable for consumption by a pet.

### BRIEF DESCRIPTION OF THE DRAWINGS

Reference will now be made, by way of example, to the accompanying drawings which show example embodiments of the present application, and in which:

FIG. 1 is a perspective view of a pet flavor grinding apparatus in accordance with example embodiments of the present disclosure;

FIG. 2 is an exploded view of the pet flavor grinding apparatus in accordance with example embodiments of the present disclosure;

FIG. 3 is a side view of the example pet flavor grinding apparatus of FIG. 1; and

FIG. 4 is a bottom view of a cap of an example pet flavor grinding apparatus of FIG. 3 taken along line FIG. 4-FIG. 4 of FIG. 3.

Similar reference numerals may have been used in different figures to denote similar components.

### DETAILED DESCRIPTION

In one aspect, a pet flavor grinding apparatus is described. The apparatus includes a pet flavor tablet. The pet flavor tablet includes a plurality of ingredients. The apparatus further includes a container defining a tablet-storing space therein storing the tablet. The apparatus also includes a a grinding mechanism coupled to the container and in communication with the tablet-storing space for receiving the tablet. The grinding mechanism includes two spaced-apart grinding elements. One of the grinding elements is movable relative to the other grinding element for grinding the tablet for discharge on pet food when the tablet is positioned in between the grinding elements.

In another aspect, a pet flavor grinding method is described. The method includes: storing a pet flavor tablet within a tablet-storing space of a container, the tablet including a plurality of ingredients; receiving the tablet in a grinding mechanism that is coupled to the container and in communication with the tablet-storing space, the grinding mechanism including two spaced-apart grinding elements, one of the grinding elements capable of being rotated relative to the other grinding element; and grinding the tablet for discharge on pet food by rotation of the rotatable grinding element when the tablet is positioned in between the grinding elements.

Other aspects will be apparent from the following description of example embodiments and the associated figures.

Grinding Apparatus

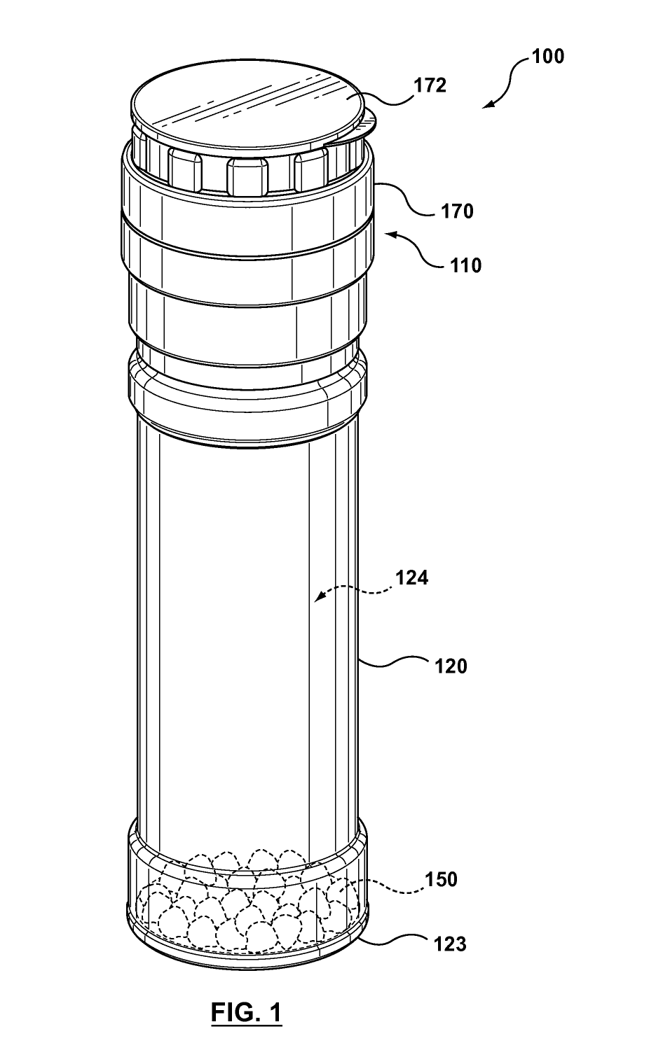

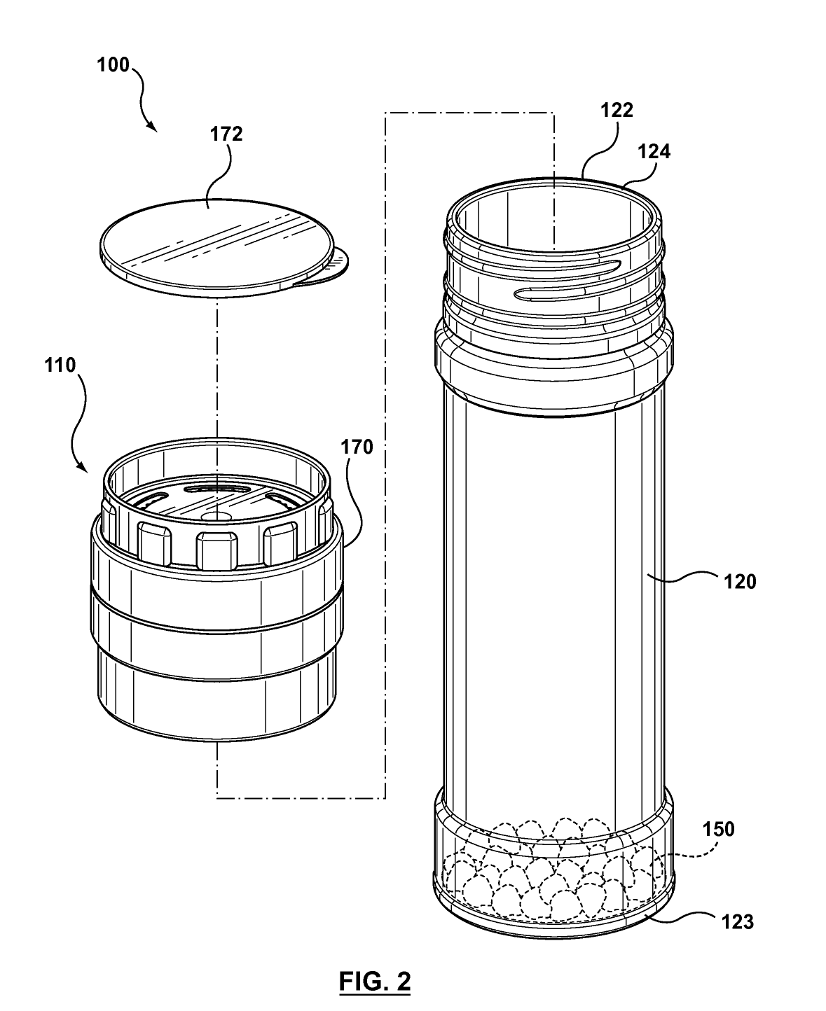

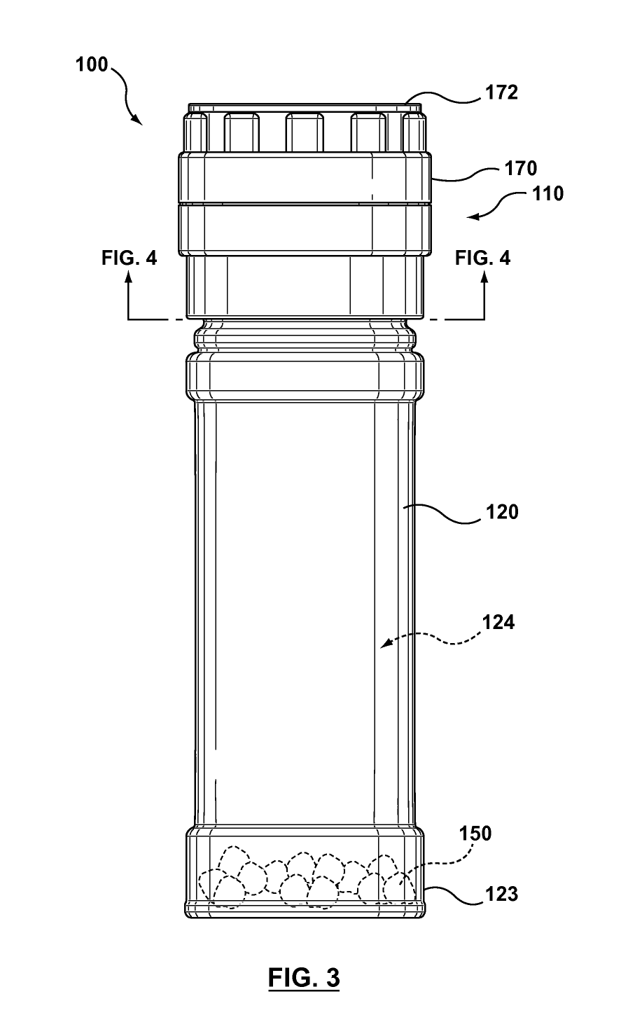

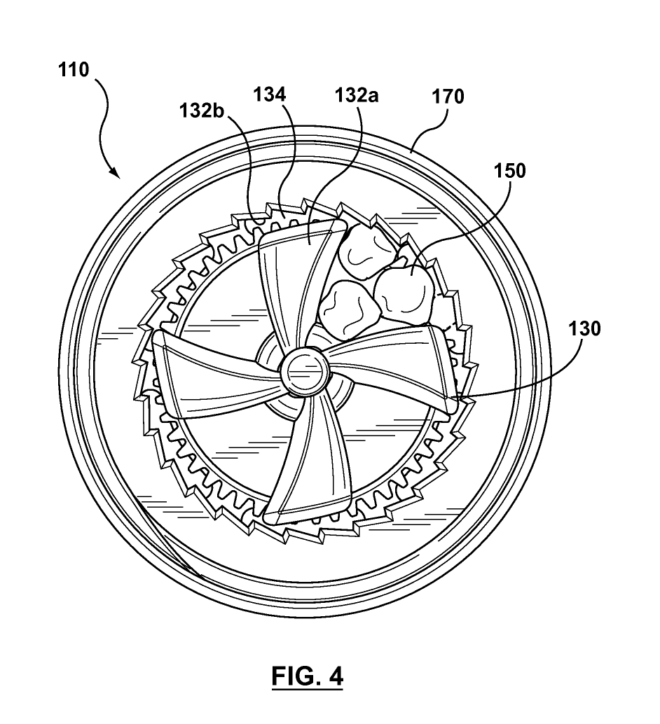

Reference will be made to FIGS. 1 to 4 which illustrate an example pet flavor grinding apparatus 100. FIGS. 1 to 4 each illustrate the pet flavor grinding apparatus 100 using a different view. For example, FIG. 1 illustrates a perspective view, FIG. 2 illustrates an exploded view, FIG. 3 illustrates a side view and FIG. 4 illustrates a bottom view of a cap of an example pet flavor grinding apparatus of FIG. 3 taken along line FIG. 4-FIG. 4 of FIG. 3. Features and components of the pet flavor grinding apparatus 100 will now be described.

The pet flavor grinding apparatus 100 is used to break down a pet flavor tablet 150 into smaller parts. The pet flavor tablet 150 may be referred to as simply a tablet 150 at various portions of this document. The pet flavor grinding apparatus 100 may be used to grind the tablet 150 into smaller pieces, which may be referred to as grinds. These grinds may be applied to food for consumption by a pet. For example, these grinds may be applied to pet food. Pet food is food specifically manufactured for consumption by pets. In some instances, the grinds may be applied to food that is not pet food. For example, the grinds may be applied to human food.

In the example embodiment of FIGS. 1 to 4, the pet flavor grinding apparatus 100 includes a container 120 and a grinding mechanism 130 which is coupled to the container 120. The container 120 defines a tablet-storing space 124 which stores one or more tablets 150.

The container 120, in the example embodiment, includes a top end 122 and a bottom end 123. As shown in FIG. 2, the top end 122 is open while the bottom end 123 is closed. The closed bottom end 123 has an external surface which is flat to support the pet flavor grinding apparatus 100 when it is set on a surface, such as a table.

In the example, the grinding mechanism 130 is provided on a cap 110 of the container 120. The cap 110 is removably attached to the container 120 at a top end 122 of the container. For example, in the perspective view of FIG. 1, the cap 110 is attached to the container 120, while in the exploded view of FIG. 2, the cap 110 is separated from the container 120. In the example embodiment, the cap 110 and the top end 122 of the container 120 are both threaded and the threading is used to attach the cap 110 to the container 120. That is, the cap 110 may be screwed onto the container 120 using the threading. When the cap 110 is attached to the container, the container 120 is closed; the open top end 122 is covered by the cap 110.

When the cap 110 is removed, pet flavor tablets 150 may be added to the tablet-storing space 124 defined by the container 120 via the open top end 122. In such cases, as illustrated, the tablets 150 may fall (by the action of gravity) towards the bottom end 123 of the container 120 when the apparatus 100 is maintained in an upright position.

The grinding mechanism 130 is in communication with the tablet-storing space 124, and accordingly may receive the stored tablets 150. Since the grinding mechanism 130 is located near the top end 122 of the container 120, the tablets 150 contact the grinding mechanism when the apparatus 100 is rotated upside down. In this position, gravity draws the tablets to the grinding mechanism.

The grinding mechanism 130 may include two spaced apart grinding elements 132a, 132b (i.e. an inner grinding element 132a and an outer grinding element 132b) that form a spacing 134 in between them. The spacing 134 is in communication with the tablet-storing space 124, and tablets 150 may be received in the spacing 134 from the tablet-storing space 124.

One of the grinding elements is rotatable or otherwise movable relative to the other of the grinding elements. In the example illustrated, the inner grinding element 132a includes one or more blades and the outer grinding element 132b includes teeth. The outer grinding element 132b is provided on a rotatable portion 170 of the cap 110. The rotatable portion 170 of the cap 110 is rotatable relative to other portions of the cap 110 (such as the outer grinding element 132b). The rotatable portion 170 of the cap 110 may be rotatably mounted on the other portions of the cap 110 (i.e., it may be rotatably attached to the non-rotatable portions of the cap 110) and, at least a portion of the rotatable portion 170 is exposed to allow a user to engage that portion. More particularly, a user may rotate the rotatable portion 170 by gripping the rotatable portion 170 in one hand and the container 120 in the other hand and applying forces using each hand in generally opposing directions. More particularly, the hand gripping the container 120 prevents the container from spinning while a force is applied to the rotatably portion 170.

The rotatable portion rotates about an axis of rotation and, in the example illustrated, the container 120, the cap 110, the rotatable portion 170, the inner grinding element 132a and the outer grinding element 132b are all centered on the axis of rotation. In the example illustrated, the inner grinding element 132b does not move relative to the container 120. The inner grinding element 132a is, in the example illustrated, propeller-shaped (it may also be referred to as fan-shaped). In the example illustrated, the propeller-shaped inner grinding element includes four angled blades. Each blade has a sharp edge for chopping the tablet 150 into grinds. More particularly, rotation of the rotatable portion 170 of the cap 110 causes rotation of the outer grinding element 132b, which is attached to the rotatable portion 170. Under such rotation, the teeth (or other grinding feature) of the outer grinding element 132b push a tablet 150 against the inner grinding element 132a, causing the tablet 150 to be broken down.

Accordingly, when tablets 150 are positioned in between the grinding elements 132a, 132b, the rotation of the inner grinding element 132a with respect to the outer grinding element 132b grinds the tablets 150. In such example embodiments, grains from the grinded tablets (i.e. the residue or grinds) may be discharged from the spacing 134, and the apparatus 100. Such grains may be directed to be discharged on pet food (or other food to be consumed by a pet) so as to provide an additive for the pet food.

In some embodiments, the inner grinding element 132a and/or the outer grinding element 132b may be of other shapes apart from those illustrated in FIGS. 1 to 4. For example, in at least some example embodiments, the inner grinding element 132a may not be propeller-shaped. Rather, the inner grinding element 132a may be comprised of teeth (i.e. a series of protrusions). Similarly, the outer grinding element 132b may not be cylindrically shaped. Similarly, in some embodiments, the outer grinding element 132b may not have teeth. The outer grinding element 132b may instead have other features that may facilitate breakdown of the tablet.

Further, it will be appreciated that the grinding mechanism may have multiple grinding stages. For example, in some embodiments, the grinding mechanism may have a first grinding stage located near the container 120 which breaks the tablets 150 down into medium-sized grinds and a second grinding stage located downstream from the first grinding stage (i.e. located further away from the container 120 than the first grinding stage) which breaks the tablets 150 down into smaller grinds. In some embodiments, the first grinding stage may resemble that illustrated in FIGS. 1 to 4 (e.g. it may be constructed of an inner grinding element which is propeller-shaped and an outer grinding element which includes teeth) and the second grinding stage may be of a different configuration. For example, the second grinding stage may include an inner grinding element which includes teeth and an outer grinding element which also includes teeth.

Further, while the example illustrates grinding elements that include blades and teeth, in other embodiments, other features could be used instead of blades and teeth. For example, the grinding elements 132a, 132b may include graters, edges, or other types of objects to grind the tablets.

Furthermore, in some embodiments, the grinding mechanism may be located at the bottom end 123 of the container 120 instead of the top end 122. In such embodiments, the bottom end 123 could be open. In some embodiments, the rotatable portion 170 of the apparatus 100 is located at an opposite end of the container 120 as the grinding mechanism 130. For example, the rotatable portion could be attached at the top end 122 and the grinding mechanism 130 at the bottom end 123 and a rotatable shaft could connect the rotatable portion to the grinding mechanism 130. For example, the rotatable shaft could connect the rotatable portion 170 to the inner grinding element 132a which could be rotatable responsive to rotation of the shaft.

As illustrated in FIG. 2, in some embodiments, the apparatus 100 may include a second cap 172. In the example illustrated, the second cap may be attached to the cap 110 on an exterior surface of the cap 110. The second cap 172 may serve a number of functions including, for example, sealing the grinding mechanism 130 when not in use, preventing fingers or other objects from entering the grinding area, etc.

In some embodiments, the apparatus 100 has one or more openings on the cap 110 and/or second cap 170 downstream from the grinding mechanism (i.e. on the side of the grinding mechanism that expels grinds) that are sized to only allow grinds having a desired maximum size to pass through to outside the apparatus 100; grinds that are over the maximum size remain within the apparatus 100.

In at least some embodiments, one or more of the components of the apparatus 100 may be constructed of polycarbonate. For example, in at least some embodiments, any one or more of the following components may be constructed of polycarbonate: the inner grinding element 132a, the outer grinding element 132b and/or the cap 110.

Pet Flavor Tablet

The pet flavor tablet 150 is a tablet 150 that includes a plurality of ingredients. The plurality of ingredients may include, for example, two ingredients, three ingredients, four ingredients, five ingredients or, in some embodiments, more than five ingredients. The plurality of ingredients may be derived from animal based products and/or non-animal based products (e.g. vegetarian products). Each of the plurality of ingredients may have varying nutritional content. Also, each of the plurality of ingredients may provide varying health benefits to a pet when consumed by the pet. Accordingly, the tablet 150 is made from a combination of ingredients that provide different nutritional content and/or health benefits. Further, various types of tablets 150 of differing combination of ingredients may be made to provide different flavors and/or health benefits to the pet.

The tablet 150 may be manufactured by various processes. For example, in at least some examples, the tablet 150 may be manufactured by an extrusion process. Extrusion is a process used to create objects (e.g. tablets 150) that are of fixed cross-sectional profiles. A material is pushed or drawn through a die of a desired cross-section to create the object (referred to as the “extruded” material). In such cases, a multitude of ingredients may be combined to create a dough. In at least some example embodiments, the dough may include one or more base ingredients (such as, sweet potatoes, quinoa, and/or brewer's yeast, etc.) and/or bulking ingredients (such as, tapioca). The dough may then be combined with other ingredients, such as flakes (which may be vegetable flakes in some embodiments. Example flakes are described in the discussion of the ingredients below). For example, the dough may be sprinkled with the flakes, and mixed to form a homogenous dough mix. The dough mix may then be extruded i.e. pushed or drawn through a die of a desired cross-section (which may be cylindrical shaped, spherical shaped or other types of shape). The result is formation of one or more tablets 150 in the form of “extruded” bits. The tablets 150 derive their shape from the die. More specifically, the tablets derive their shape based on the manner by which they are cut or shaped by the corresponding cross-sectional shape of the die. As such, the tablets 150 may be cylindrically shaped, spherically shaped, etc. As illustrated in FIG. 4, in at least one embodiment, the tablets 150 are cylindrical in shape.

To allow the tablets to be easily broken apart by the grinder, the tablets may be small in size. More particularly, in at least some embodiments, each tablet 150 may have a width taken along any cross section of the tablet 150 that is less than 5 millimeters. In some embodiments, each tablet 150 may have a width taken along any cross section of the tablet 150 that is less than 4 millimeters.

In at least some example embodiments, rather than adding the flakes to the dough, the flakes may instead be added to the extruded bits. That is, the flakes may be combined with the extruded bits (which are by-product of the extrusion process described above) to create the tablets 150. In at least some example embodiments, other processes may be implemented in order to manufacture the tablets 150, such as a cold press process, pressed powder tab process, molding process, etc.

As mentioned above, in at least some example embodiments, the ingredients within a tablet 150 may be of varying types and provide various nutritional content. For example, the ingredients may be or include one or more of a carbohydrate, fatty acid, anti-oxidant, fiber, protein, vitamin, food acid, mineral, fat, etc. The different types of nutritional content may be derived from various ingredients.

For example, in at least some embodiments, at least one of the ingredients of the tablet 150 may be a carbohydrate. An ingredient which is classified as a carbohydrate is an ingredient that is primarily comprised of carbohydrates and has a small amount of fat and protein. The ingredient(s) that is/are a carbohydrate may include any one or more of: a sweet potato, tapioca, quinoa, red split lentil, mannan-oligosaccharide (MOS), fructo-oligosaccharide (FOS), galacto-oligosaccharide (GOS) or malted barley. Other ingredients that are carbohydrates may be included in the tablet 150 in other embodiments.

In at least some embodiments, at least one of the ingredients of the tablet 150 may be an ingredient that includes a fatty acid (such as an Omega-3 and/or Omega-6 fatty acid). Such an ingredient may be referred to as fatty acid ingredient. The fatty acid ingredient(s) may include any one or more of: flaxseed, whole pea, green algae, soybean oil, olive oil, vegetable oil, aloe vera or wheat germ. Other ingredients that are fatty acids may be included in the tablet 150 in other embodiments.

In at least some embodiments, at least one of the ingredients of the tablet 150 may act as an anti-oxidant (i.e, may be an anti-oxidant ingredient). That is, one of the ingredients may have anti-oxidant properties. The ingredients(s) that acts as the anti-oxidant(s) may include any one or more of: sweet potato (which includes beta-carotene), yeast culture, brewer yeast, olive oil, pumpkin seed, blueberry powder, turmeric root, carrot flakes, tomato flakes, spinach flakes or orange peel granules. Other ingredients that are anti-oxidants may be included in the tablet 150 in other embodiments.

In at least some embodiments, at least one of the ingredients of the tablet 150 may be a fiber-source. The ingredient(s) that is a fiber-source may include, for example any one or more of: sweet potato, beet flakes, whole pea, red split lentil, alfalfa meal, hulled pumpkin seed, blueberry powder, carrot flakes, malted barley or wheat germ. Other ingredients that are fiber sources may be included in the tablet 150 in other embodiments.

In at least some embodiments, at least one of the ingredients of the tablet 150 may be a high source of protein (i.e., a “protein-source”). The ingredient(s) that is/are a high source of protein may include any one or more of: whole pea, red split lentil, yeast culture, ,brewer's yeast, or wheat germ. Other ingredients that are protein sources may be included in the tablet 150 in other embodiments.

In at least some embodiments, one or more of the ingredients of the tablet 150 may include one or more vitamins. The ingredient(s) that include vitamins may include any one or more of: sweet potato (which is a source of vitamin C), quinoa (which is a source of vitamin B), beet flakes, red split lentil, kelp meal, yeast culture, Brewer's yeast (which is a source of vitamin B), olive oil (which is a source of vitamins A, D, E and K), tomato flakes, spinach flakes, or wheat germ. Other ingredients that include vitamins may be included in the tablet 150 in other embodiments.

In at least some embodiments, one or more of the ingredients of the tablet 150 may be a food acid. Food acids are generally used to make flavors sharper and, in at least some embodiments, to act as preservatives and/or antioxidants. The ingredients that are food acids may be any one or more of: citric acid, malic acid, fumaric acid, lactic acid or calcium butyrate. Other ingredients may be used as food acids in other embodiments.

In at least some embodiments, one or more of the ingredients of the tablet 150 may include a mineral. The minerals may include any one or more of calcium, sodium, chloride, potassium, copper, fluoride, iodine, manganese, molybdenum, selenium, iron, or zinc. The ingredient(s) of the tablet that include a mineral may include any one or more of: quinoa (which is a source of calcium, phosphorus, iron, manganese, magnesium, and copper), kelp meal, yeast culture (which is a source of zinc). Other ingredients that include minerals may be used in other embodiments.

The ingredients described above may be used to provide a tablet 150 having varied nutritional content. While the tablet 150 includes multiple ingredients, it will be appreciated that any one of the ingredients may, itself, provide nutritional content of multiple types. For example, the inclusion of sweet potato as an ingredient may provide carbohydrate, anti-oxidant, fiber and mineral nutrition content.

As mentioned above, in at least some example embodiments, the ingredients within the tablet 150 may provide various health benefits to a pet when consumed by the pet. For example, some ingredients of the tablet 150 may provide health benefits associated with the pet's immune system, skin and coat, digestive tract, intestinal tract, urinary tract, bones and joints, oral region, circulatory system, mood and behavior, or other areas of the pet. Different ingredients may provide different types of health benefits to the pet.

By way of example, ingredients which aid in immune system strength may include one or more of lutein, echinacea, green tea extract, beta-glucanes and/or any of the anti-oxidants and vitamins listed above. Ingredients which aid in skin and coat may include one or more of kelp meal, yeast culture, soybean oil, coconut oil, olive oil, brewer's yeast, orange peel granules or spinach flakes. Ingredients which aid in digestive tract regulation may include one or more of fiber, yeast culture, coconut oil, thyme, carob (e.g. helps in maintaining stool hardness), yucca schidigera (e.g. helps in reducing stool odors) extract, ginger root, fennel, dandelion, catnip extract, orange peel granules, brewer's yeast, catnip powder or betaine. Ingredients which provide anti-inflammation properties (e.g. for bones and joints) may include one or more of hulled pumpkin seed, fenugreek or aloe vera. Ingredients which provide oral health benefits may include one or more of parsley flakes (e.g. helps in fighting bad breath), alfalfa meal (e.g. helps in controlling bad breath) or green tea extract (e.g. helps in controlling tartar). Ingredients which aid in urinary tract health may include one or more of betaine, dandelion or cranberry extract. Ingredients which aid in intestinal health may include one or more of any of the food acids noted above, calcium butyrate or betaine. Ingredients which aid in circulatory system health may include one or more of orange peel granules or olive oil. Ingredients which aid in psychological health (e.g. mood and behavior) may include one or more of catnip powder or catnip extract.

In at least some example embodiments, a tablet 150 may include any one or a combination of the ingredients noted above, thus providing one or more different kinds of health benefits to a pet when consumed by the pet. Moreover, a single ingredient may provide a multitude of benefits (for example, olive oil may aid in skin and coat health as well as circulatory system health). In at least some example embodiments, other ingredients not specifically listed may be included within a tablet 150 to provide one or more of the mentioned or non-mentioned health benefits.

Accordingly, tablets 150 of varying ingredient combinations may be manufactured according to one of the processes described above to provide different nutritional content and health benefits. In such embodiments, tablets 150 may be manufactured based upon the desired nutritional content and health benefits. As such, a combination of ingredients is selected to provide the desired nutritional content and health benefits. In at least some example embodiments, such a combination of ingredients to be included within a tablet 150 is further selected based on pet taste and/or aromatic preferences. For example, dogs and cats may have different taste or smell preferences for foods (i.e. they may each prefer the flavor or scent of different ingredients). Therefore, two or more kinds of tablets 150 that provide the same or similar nutritional content and/or health benefits may nevertheless have different ingredients so as to meet the taste preferences of different types of pets. For example, one tablet 150 may include ingredients that are preferred by dogs while another tablet 150 may include ingredients that are preferred by cats.

Additionally, different tablets 150 may be manufactured to provide different health benefits and/or nutritional content to a pet consuming such tablets. For example, tablets 150 that are directed to at least provide digestion-related health benefits may be manufactured for consumption by a pet. In some embodiments, such a tablet 150 may be specially formulated for consumption by a particular type of pet (e.g. dogs). A tablet 150 that is formulated to assist digestive health may be referred to as a “digestion” tablet, and may include the following ingredients, in an example embodiment: sweet potatoes, tapioca, quinoa, beet flakes, flaxseed, peas, lentils, natural flavor, kelp, lecithin, yeast culture, alfalfa meal, green algae, soybean oil, olive oil, coconut oil, pumpkin seeds, blueberries, mannan-oligosaccharides (MOS), carob, fructo-oligosaccharides (FOS), galacto-oligosaccharides (GOS), betaine, calcium butyrate, yucca schidigera extract, yeast extract, vegetable oil, ginger root, beta-glucanes, turmeric root, fenugreek, fennel, dandelion, thyme extract, fumaric acid, lactic acid, marigold extract, L-carnitine, echinacae, green tea extract, catnip extract, citric acid, malic acid and/or aloe vera. It will be appreciated that not all of the ingredients of the “digestion” tablet are used to aid in digestion; some of the ingredients may be used for other purposes (e.g. to provide other nutritional content, to provide bulking, etc.). It will also be appreciated that one or more of the ingredients listed above may be omitted or varied in at least some embodiments and that other ingredients may be included in other embodiments apart from those specifically listed above.

In a similar manner, a tablet 150 that improves immune system function in a pet consuming the tablet 150 may be manufactured. In some embodiments, such a tablet 150 may be specially formulated for consumption by a particular type of pet (e.g. dogs). A tablet 150 that is formulated to improve immune system functions may be referred to as an “immune system” tablet, and may, in an embodiment, include the same ingredients as mentioned above with respect to the digestion tablet with the exception of certain ingredients. For example, the immune system tablet may not include beet flakes, and may additionally include carrot flakes (e.g. ingredients which may strengthen the immune system of a pet when consumed by the pet). It will be appreciated that not all of the ingredients of the “immune system” tablet are used to aid in immune system function; some of the ingredients may be used for other purposes (e.g. to provide other nutritional content, to provide bulking, etc.). It will also be appreciated that one or more of the ingredients listed above may be omitted or varied in at least some embodiments and that other ingredients may be included in other embodiments apart from those specifically listed above.

In a similar manner, a tablet 150 that at least provides omega fatty acids and their associated health benefits may be manufactured. In some embodiments, such a tablet 150 may be specially formulated for consumption by a particular type of pet (e.g. dogs). A tablet 150 that includes omega fatty acids may be referred to as an “omega” tablet, and may, in an embodiment, include the same ingredients as mentioned above with respect to the digestion supplement tablet with the exception of certain ingredients. The omega tablet may not include beet flakes, and may additionally include sunflower seeds. It will be appreciated that not all of the ingredients of the “omega” tablet include omega fatty acids; some of the ingredients may be used for other purposes (e.g. to provide other nutritional content, to provide bulking, etc.). It will also be appreciated that one or more of the ingredients listed above may be omitted or varied in at least some embodiments and that other ingredients may be included in other embodiments apart from those specifically listed above.

As noted above, in some embodiments, a tablet may be specifically formulated for a certain type of pet. In some embodiments, a tablet may be specifically formulated for consumption by a cat. Such a tablet may be referred to as a “cat” tablet and may, in at least some embodiments, include one or more ingredients which are enticing to cats; for example, brewer's yeast, malted barley, catnip powder (or catnip in another form) and/or cranberry extract. In one example embodiment, a “cat” tablet includes the same ingredients as mentioned above with respect to the digestion tablet with the exception of certain ingredients. The “cat” tablet may not include tapioca, beet flakes, natural flavor, yeast culture, alfalfa meal and hulled pumpkin seeds. The tablet may additionally include malted barley, wheat germ, catnip powder and cranberry extract. In such example embodiments, the omission and inclusion of some of the ingredients may be based on the taste and/or odor preferences of cats. For example, cats generally do not enjoy consuming tapioca, but enjoying consuming brewer's yeast, malted barley, catnip powder and cranberry extract. Accordingly, tapioca is omitted from the tablet, and brewer's yeast, malted barley, catnip powder and cranberry extract are included in the tablet. It will be appreciated that not all of the ingredients of the “cat” tablet are necessarily enticing to a cat; some of the ingredients may be used for other purposes (e.g. to provide other nutritional content, to provide bulking, etc.). It will also be appreciated that one or more of the ingredients listed above may be omitted or varied in at least some embodiments and that other ingredients may be included in other embodiments apart from those specifically listed above.

As noted above in the discussion of FIGS. 1 to 4, the tablets 150 may be included in the pet flavor grinding apparatus. More particularly, the container 120 may store one or more of the tablets 150. In some embodiments, the container may also store one or more other food sources. For example, in some embodiments, in addition to a tablet 150, the container 120 may also store a seed (e.g. sunflower seed), a nut (e.g. peanut) and/or a dehydrated or freeze dried fruit or vegetable bit.

In at least some example embodiments, other types of tablets 150 directed to provide specific nutritional content and health benefits for dogs, cats and/or other pets (such as, birds, hamsters, etc.) may also be manufactured. Such tablets 150 may or may not include one or more of the ingredients list above, and may additionally include other ingredients not listed above. Moreover, one or more of the ingredients within a tablet 150 may be substituted with one or more other ingredients. In such cases, the substituted ingredient may provide a similar texture and/or mixing property as the ingredient being substituted. Additionally, the substituted ingredient may provide lessor or greater nutritional content and/or health benefits than the ingredient being substituted. For example, sweet potatoes may be substituted with potatoes, olive oil may be substituted with avocado oil or grape seed oil, etc. Further, the above mentioned ingredients are primarily derived from non-animal based products (i.e. vegetarian sources). As mentioned above, in at least some example embodiments, the ingredients may instead of or additionally by derived from animal-based products. For example, ingredients such as freeze egg powder, yoghurt powder, freeze dried animal protein powder, etc. may be included within a tablet 150.

The pet flavor grinding apparatus 100 described herein may be used for grinding the tablets 150. More particularly, a pet flavor grinding method may use the apparatus 100 to grind the tablet onto pet food. In one such method, a pet flavor tablet 150 is stored within the tablet-storing space 124 of the container 120. Then, the tablet is received in the grinding mechanism that is coupled to the container and in communication with the tablet-storing space. The tablet 150 is then ground for discharge on pet food by rotating the rotatable grinding element when the tablet is positioned in between the grinding elements. The grinds may then be applied to pet food and provided to a pet. The pet may, in various embodiments, include a reptile, dog, cat, rabbit, fish, snake, hamster, or another household pet.

Other example embodiments of the present disclosure will be apparent to those of ordinary skill in the art from a review of the following detailed description in conjunction with the drawings.

It will be appreciated that one or more of the ingredients described herein may provide benefits which are not specifically listed herein and that one or more of the benefits ascribed to a particular ingredient may not be provided by that ingredient in all embodiments. The various example embodiments presented above are merely examples. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

What is claimed is:

1. A pet flavor grinding apparatus, the apparatus comprising:
a pet flavor tablet, the pet flavor tablet including a plurality of ingredients;
a container defining a tablet-storing space therein storing the tablet; and
a grinding mechanism coupled to the container and in communication with the tablet-storing space for receiving the tablet, the grinding mechanism including two spaced-apart grinding elements, one of the grinding elements movable relative to the other grinding element for grinding the tablet for discharge on pet food when the tablet is positioned in between the grinding elements.

2. The pet flavor grinding apparatus of claim 1, wherein the plurality of ingredients include three or more ingredients.

3. The pet flavor grinding apparatus of claim 1, wherein the plurality of ingredients include at least a carbohydrate, the carbohydrate being one or more of sweet potato, tapioca, quinoa, red split lentil, mannan-oligosaccharide, fructo-oligosaccharide, galacto-oligosaccharide or malted barley.

4. The pet flavor grinding apparatus of claim 1, wherein the plurality of ingredients include a fatty acid ingredient, the fatty acid ingredient being one or more of flaxseed, whole pea, green algae, soybean oil, olive oil, vegetable oil, aloe vera or wheat germ.

5. The pet flavor grinding apparatus of claim 1, wherein the plurality of ingredients include at least one anti-oxidant ingredient, the anti-oxidant ingredient being one or more of sweet potato, yeast culture, olive oil, hulled pumpkin seed, blueberry powder, turmeric root, carrot flakes, tomato flakes, spinach flakes or orange peel granules.

6. The pet flavor grinding apparatus of claim 1, wherein the plurality of ingredients include at least one fiber source, the fiber source being one or more of sweet potato, beet flakes, whole pea, red split lentil, alfalfa meal, hulled pumpkin seed, blueberry powder, carrot flakes, malted barley or wheat germ.

7. The pet flavor grinding apparatus of claim 1, wherein the plurality of ingredients include at least one protein source, the protein source being one or more of whole pea, red split lentil, yeast culture, brewer's yeast or wheat germ.

8. The pet flavor grinding apparatus of claim 1, wherein the plurality of ingredients include at least a vitamin, the ingredients including the vitamin being one or more of sweet potato, quinoa, beet flakes, red split lentil, kelp meal, yeast culture, olive oil, tomato flakes, spinach flakes, brewer's yeast or wheat germ.

9. The pet flavor grinding apparatus of claim 1, wherein the plurality of ingredients include at least a food acid, the food acid including one or more of citric acid, malic acid, fumaric acid, lactic acid or calcium butyrate.

10. The pet flavor grinding apparatus of claim 1, wherein one or more of the plurality of ingredients include at least a mineral, the ingredient including the mineral being one or more of quinoa, kelp meal, yeast culture or brewer's yeast.

11. The pet flavor grinding apparatus of claim 1, wherein one or more of the plurality of ingredients aid in immune system strength of a pet, the plurality of ingredients including one or more of lutein, echinacea, green tea extract or beta-glucanes.

12. The pet flavor grinding apparatus of claim 1, wherein one or more of the plurality of ingredients aid in skin and coat health of a pet, the plurality of ingredients including one or more of kelp meal, yeast culture, soybean oil, coconut oil, olive oil, brewer's yeast, orange peel granules or spinach flakes.

13. The pet flavor grinding apparatus of claim 1, wherein one or more of the plurality of ingredients aid in digestive tract regulation of a pet, the plurality of ingredients including one or more of fiber, yeast culture, coconut oil, thyme, carob, yucca schidigera extract, ginger root, fennel, dandelion, catnip extract, orange peel granules, brewer's yeast, catnip powder or betaine.

14. The pet flavor grinding apparatus of claim 1, wherein one or more of the plurality of ingredients provide anti-inflammation properties for a pet, the plurality of ingredients including one or more of hulled pumpkin seed, fenugreek or aloe vera.

15. The pet flavor grinding apparatus of claim 1, wherein one or more of the plurality of ingredients provide oral health properties for a pet, the plurality of ingredients including one or more of parsley flakes, alfalfa meal or green tea extract.

16. The pet flavor grinding apparatus of claim 1, wherein one or more of the plurality of ingredients aid in urinary tract health of a pet, the plurality of ingredients including one or more of betaine, dandelion or cranberry extract.

17. The pet flavor grinding apparatus of claim 1, wherein one or more of the plurality of ingredients aid in intestinal health of a pet, the plurality of ingredients including one or more of calcium butyrate or betaine.

18. The pet flavor grinding apparatus of claim 1, wherein one or more of the plurality of ingredients aid in circulatory system health of a pet, the plurality of ingredients including one or more of orange peel granules or olive oil.

19. The pet flavor grinding apparatus of claim 1, wherein the tablet is formed by an extrusion process, the extrusion process includes:
combining the plurality of ingredients to form a dough; and
extruding the dough through a die to create the tablet.

20. A pet flavor grinding method, the method comprising:
storing a pet flavor tablet within a tablet-storing space of a container, the tablet including a plurality of ingredients;
receiving the tablet in a grinding mechanism that is coupled to the container and in communication with the tablet-storing space, the grinding mechanism including two spaced-apart grinding elements, one of the grinding elements capable of being rotated relative to the other grinding element; and
grinding the tablet for discharge on pet food by rotation of the rotatable grinding elements.
